(19) United States
(12) Patent Application Publication
(10) Pub. No.: US 2013/0057505 A1
(43) Pub. Date: Mar. 7, 2013

(54) ELECTROMAGNETIC INDUCTIVE INPUT APPARATUS

(71) Applicants: Joe YU, New Taipei City (TW); Wen-Yuan HUANG, New Taipei City (TW)

(72) Inventors: Joe YU, New Taipei City (TW); Wen-Yuan HUANG, New Taipei City (TW)

(73) Assignee: UC-Logic Technology Corp., New Taipei City (TW)

(21) Appl. No.: 13/432,822

(22) Filed: Mar. 28, 2012

(30) Foreign Application Priority Data
Sep. 6, 2011 (TW) 100132097

(51) Int. Cl. G06F 3/046

(52) U.S. Cl. 345/174; 178/18.07

(57) ABSTRACT

An electromagnetic inductive input apparatus includes a signal transmitting device including a signal transmitter, and a signal receiving device. The signal receiving device includes a transparent substrate, first and second sets of transparent conductors disposed on the transparent substrate, and formed as spacedly arranged straight non-loop lines, and a control device electrically coupled to the transparent conductors and operable to detect a detected signal from the transparent conductors, and to determine a position of the signal transmitting device relative to the transparent substrate.

### CROSS-REFERENCE TO RELATED APPLICATION

This application claims priority to Taiwanese Application No. 100132097, filed on Sep. 6, 2011.

### BACKGROUND OF THE INVENTION

1. Field of the Invention

The invention relates to an input apparatus, and more particularly to an electromagnetic inductive input apparatus.

2. Description of the Related Art

Referring to FIG. 1 and FIG. 2, a conventional digitizer input apparatus comprises an active pen 8 for generating a magnetic field, and a digitizer tablet 9 for sensing the magnetic field.

The active pen 8 has a power source 81, an oscillator circuit 82, a ferrite core 83, and a coil 84. The ferrite core 83 and the coil 84 serve as inductive components to generate the magnetic field. Due to the active pen 8 having the internal power source 81, electricity may be continuously provided to the oscillator circuit 82 so that an electromagnetic wave in a certain frequency may be transmitted.

The digitizer tablet 9 has a set of sensing coils X1˜X25 parallelly arranged in an X-axis direction, a selecting circuit 91 including a plurality of switching components, and a control unit 90 controlling the selecting circuit 91. One end of each of the sensing coils X1˜X25 is grounded, while the other end of each of the sensing coils X1˜X25 is connected to a respective one of the switching components. The control unit 90 obtains a sensed signal from each of the sensing coils X1˜X15 by sequentially controlling each of the switching components. It should be noted that FIG. 2 only shows the set of sensing coils X1˜X25 configured for X-axis coordinate detection, and does not show another set of sensing coils, which is also included in the digitizer tablet 9, arranged in a Y-axis direction that is transverse to the X-axis direction, and configured for Y-axis coordinate detection.

A gap S1 between the electromagnetic fields generated by the active pen 8, and a pattern overlap S2 among adjacent ones of the sensing coils X1˜X25 are configured to enable one of the sensing coils X1˜X25 to output a strongest sensed signal when the active pen 8 is at a position corresponding to said one of the sensing coils X1˜X25. After the control unit 90 of the digitizer tablet 9 sequentially scans the sensing coils X1˜25, and compares magnitudes of the sensed signals from the sensing coils X1˜X25, the position of the active pen 8 relative to the digitizer tablet 9 could be obtained accordingly.

Conventional sensing coils X1˜X25 are wires made of metal, such as gold or copper, and resistance of a single wire is under 1 ohm. While the low resistance facilitates transmission of the sensed signals, the metal sensing coils are only suited for opaque digitizer tablets.

A capacitive touch screen, which is commonly used at present, is transparent and made through an indium tin oxide (ITO) semiconductor process. Since resistance of a single ITO wire may be over 100K ohms, a higher input voltage may be needed in order to obtain a desired strength of sensed signals when ITO wires are applied in a digitizer tablet.

### SUMMARY OF THE INVENTION

Therefore, an object of the present invention is to provide an electromagnetic inductive input apparatus that has a transparent substrate and a plurality of transparent conductors in a form of straight non-loop lines thereon.

According to the present invention, an electromagnetic inductive input apparatus comprises a signal transmitting device and a signal receiving device.

The signal transmitting device includes a signal transmitter that has a conductor coil and a ferromagnetic member surrounded by the conductor coil. The signal transmitter is operable to generate a magnetic field.

The signal receiving device includes a transparent substrate, first and second sets of transparent conductors disposed on the transparent substrate, and a control device electrically coupled to the transparent conductors and operable to detect a detected signal from at least one of the transparent conductors sensing the magnetic field from the signal transmitting device, and to determine a position of the signal transmitting device relative to the transparent substrate from the detected signal. The first set of transparent conductors is in a form of straight non-loop lines spacedly arranged in a first direction, and the second set of transparent conductors is in a form of straight non-loop lines spacedly arranged in a second direction that is transverse to the first direction. The second set of transparent conductors intersects with and is electrically isolated from the first set of transparent conductors. Each of the transparent conductors has a predetermined width sufficient to impart each of the transparent conductors with a resistance lower than 1000 ohms.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a conventional active pen;

FIG. 2 is a schematic diagram illustrating a conventional digitizer tablet;

FIG. 3 is a schematic diagram illustrating a preferred embodiment of an electromagnetic inductive input apparatus according to the present invention;

FIG. 4 is a schematic diagram illustrating a first implementation of a signal receiving device of the preferred embodiment;

FIG. 5 is a schematic diagram illustrating a second implementation of the signal receiving device of the preferred embodiment;

FIG. 6 is a schematic diagram illustrating a first implementation of a signal transmitting device of the preferred embodiment;

FIG. 7 is a waveform diagram illustrating signals generated in the electromagnetic inductive input apparatus shown in FIG. 6;

FIG. 8 is a schematic diagram illustrating a second implementation of the signal transmitting device of the preferred embodiment; and

FIG. 9 is a waveform diagram illustrating signals generated in the electromagnetic inductive input apparatus shown in FIG. 8.

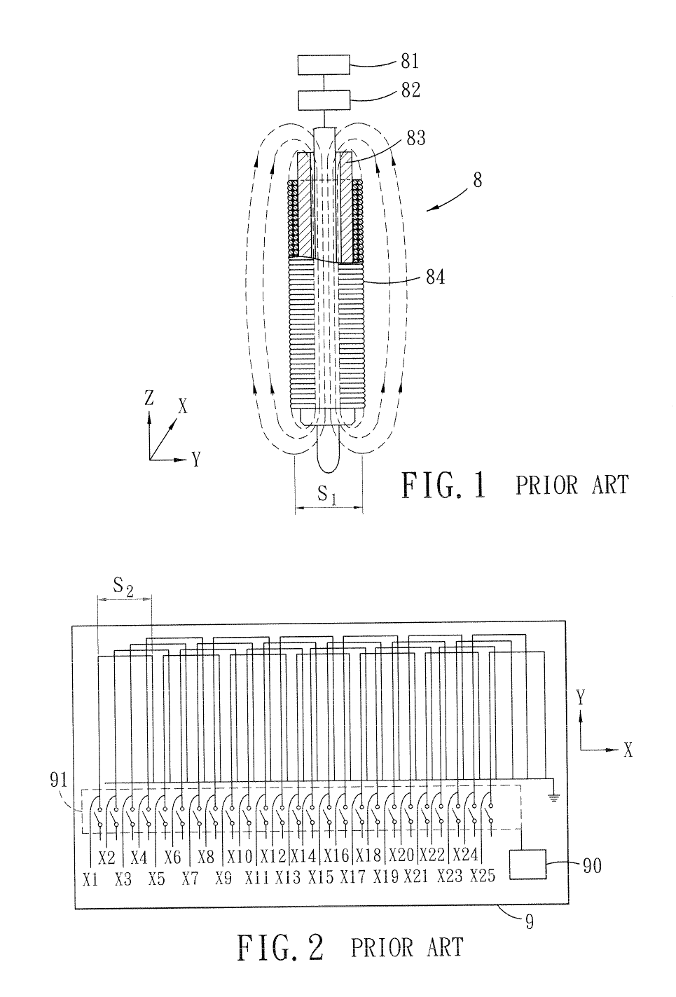

### DETAILED DESCRIPTION OF THE PREFERRED EMBODIMENT

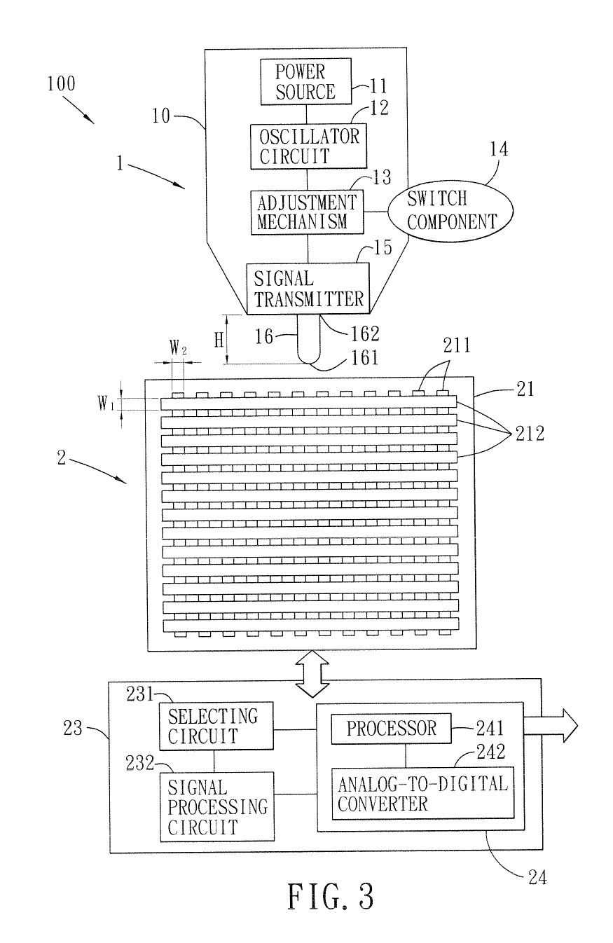

FIG. 3 illustrates a preferred embodiment of the electromagnetic inductive input apparatus 100 according to the present invention. The electromagnetic inductive input apparatus 100 comprises a signal transmitting device 1, and a signal receiving device 2 including a transparent substrate 21.

The signal transmitting device 1 has a pen body 10, a power source 11 disposed in the pen body 10, an oscillator circuit 12, an adjustment mechanism 13, a switch component 14, a signal transmitter 15, and a pen tip 16 for contacting the transparent substrate 21. The power source 11 provides power to each electronic component of the signal transmitting device 1, and the oscillator circuit 12 has a variable capacitor and/or a variable inductor. When the switch component 14 is activated, the adjustment mechanism 13 is configured to change the capacitance of the variable capacitor, or the inductance of the variable inductor, according to design of the oscillator circuit 12, so as to change a resonant frequency of the oscillator circuit 12. The resonant frequency is transmitted to the signal receiving device 2 to enable the latter to make a corresponding response. The signal transmitter 15 has a conductor coil and a ferromagnetic member surrounded by the conductor coil, and is operable to generate a magnetic field.

The signal receiving device 2 further includes first and second sets of transparent conductors 211 and 212 disposed on the transparent substrate 21, and a control device 23. The first set of transparent conductors 211 is in a form of straight non-loop lines spacedly arranged in a first direction, and the second set of transparent conductors 212 is in a form of straight non-loop lines spacedly arranged in a second direction that is transverse to the first direction. The second set of transparent conductors 212 intersects with and is electrically isolated from the first set of transparent conductors 211. The first and second sets of transparent conductors 211 and 212 may be made of indium tin oxide (ITO), which could be made by evaporation, sputtering, electro-plating, chemical vapor deposition, or wet coating for forming on the transparent substrate 21. Conductors used in other circuits may be a printed circuit, a silver paste printed circuit, or a copper wire circuit. The transparent substrate 21 may be made of fiberglass, glass, or plastics.

According to Ohm's law, resistance is inversely proportional to a sectional area of a conductor. That is, under a determined thickness, resistance is inversely proportional to a width of the conductor. Therefore, each of the first set of transparent conductors 211 has a predetermined width W₁, and each of the second set of transparent conductors 212 has a predetermined width W₂, so as to impart a desired resistance thereto to overcome high resistivity issue of the transparent material ITO and thus to ensure desired input voltages of the signal receiving device 2 and the signal transmitter 15. In this embodiment, W₁ and W₂ are both one centimeter, which is sufficient to impart each of the transparent conductors 211, 212 with a resistance lower than 1000 ohms. In this embodiment, the resistance of each of the transparent conductors 211 and 212 is about 600 ohms.

The control device 23 is electrically coupled to the transparent conductors 211 and 212, and is operable to detect a detected signal from at least one of the transparent conductors 211 and 212 sensing the magnetic field from the signal transmitting device 1. The control device 23 includes a selecting circuit 231, a signal processing circuit 232, and a control unit 24. The control unit 24 has a processor 241 and an analog-to-digital converter 242. When the first and second sets of transparent conductors 211 and 212 sense the magnetic field from the signal transmitting device 1, the control device 23 controls the selecting circuit 231 to sequentially obtain the detected signal for processing by the signal processing circuit 232. After being filtered and amplified by the signal processing circuit 232, and digitized by the analog-to-digital converter 242, the processor 241 isoperable to determine a position of the signal transmitting device 1 relative to the transparent substrate 21 according to the detected signal processed by the signal processing circuit 232 and the analog-to-digital converter 242.

The signal processing circuit 232 may include an amplifier circuit, whose gain is controllable by a program to be adjusted such that, when sensitivities of the transparent conductors 211 and 212 are not uniform, the amplifier circuit is capable of adjusting the detected signal according to compensation values stored in a signal table recorded during calibration of each of the transparent conductors 211 and 212. The signal processing circuit 232 may also include a band-pass filter, so as to receive the magnetic field generated by the signal transmitting device 1 in a specific frequency band for enhancing identification. The band-pass filter could also be adjustable to avoid environmental interference.

The present invention is based on two principles: one is the principle of electromagnetism, and the other one is that a magnetic field variation in a closed circuit generates an induced current.

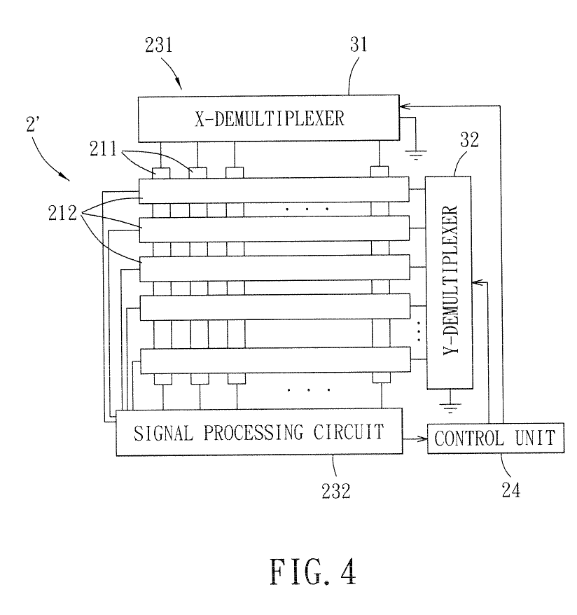

Referring to FIG. 4, a first implementation of the signal receiving device 2′ according to the present invention is shown to have the control unit 24, the selecting circuit 231 electrically coupled to the control unit 24 and each of the transparent conductors 211 and 212, and the signal processing circuit 232 electrically coupled to the control unit 24 and each of the transparent conductors 211 and 212. In this implementation, the selecting circuit 231 and the signal processing circuit 232 are connected to opposite ends of the transparent conductors 211 and 212, respectively. The selecting circuit 231 includes an X-demultiplexer 31 coupled to the first set of transparent conductors 211, and a Y-demultiplexer 32 coupled to the second set of transparent conductors 212. The X-demultiplexer 31 and the Y-demultiplexer 32 are controlled by the control unit 24 to ground a selected one of the transparent conductors 211 and 212. The signal processing circuit 232 detects and performs filter processing upon the detected signal from the selected one of the transparent conductors 211 and 212. The control unit 24 determines the position of the signal transmitting device 1 relative to the transparent substrate 21 from the detected signal processed by the signal processing circuit 232.

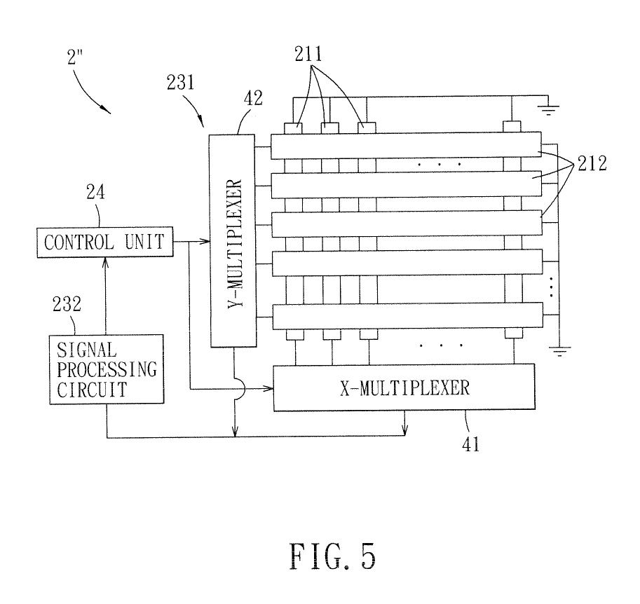

Referring to FIG. 5, a second implementation of the signal receiving device 2″ according to the present invention is shown to have the control unit 24, the selecting circuit 231 electrically coupled to the control unit 24 and each of the transparent conductors 211 and 212, and the signal processing circuit 232 electrically coupled to the control unit 24 and the selecting circuit 231. In this implementation, opposite ends of the transparent conductors 211 and 212 are connected to ground and the selecting circuit 231, respectively. The selecting circuit 231 includes an X-multiplexer 41 coupled to the first set of transparent conductors 211 and the signal processing circuit 232, and a Y-multiplexer 42 coupled to the second set of transparent conductors 212 and the signal processing circuit 232. The X-multiplexer 41 and the Y-multiplexer 42 are controlled by the control unit 24 to output the detected signal from a selected one of the transparent conductors 211 and 212. The signal processing circuit 232 detects and performs filter processing upon the detected signal from the selected one of the transparent conductors 211 and 212. The control unit 24 determines the position of the signal transmitting device 1 relative to the transparent substrate 21 from the detected signal processed by the signal processing circuit 232.

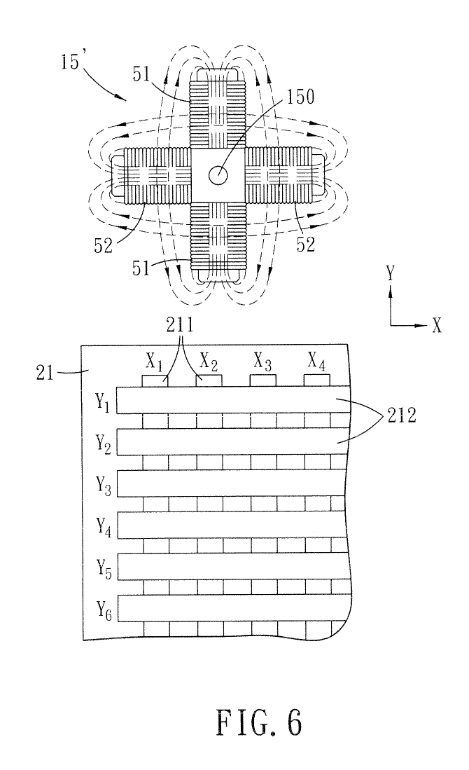

Referring to FIG. 3 and FIG. 6, a first implementation of the signal transmitter 15′ is shown to have the conductor coil with two coil parts, and the ferromagnetic member being cross-shaped and surrounded by the coil parts of the conductor coil. The ferromagnetic member may be sintered with magnetic ceramics or metal powders. One of the coil parts surrounds a first pair of opposing arm portions of the ferromagnetic member along a longitudinal direction, and the other one of the coil parts surrounds a second pair of opposing arm portions of the ferromagnetic member along a transverse direction. The cross shape is advantageous in that: in one direction, the magnetic field lines from the signal transmitter 15′ are parallel to the transparent conductors without being cut, while in the other direction, the magnetic field lines from the signal transmitter 15′ are orthogonal to the transparent conductors to result in induction. That is, the magnetic field lines from the signal transmitter 15′ could result in induction in at least one direction. It should be noted that, in other embodiments, instead of having two pairs of orthogonal arm portions, the ferromagnetic member could be L-shaped with one pair of orthogonal arm portions to have the same advantage as the cross-shaped ferromagnetic member. Therefore, the control device 23 is able to determine the position of the signal transmitting device 1 relative to the transparent substrate 21 from peak of the detected signal from at least one of the transparent conductors 211 and 212 sensing the magnetic field from the signal transmitting device 1.

In detail, the coil parts of the conductor coil surround four arm portions of the cross-shaped ferromagnetic member to form a first inductor 51 and a second inductor 52. When the oscillator circuit 12 operates, the first inductor 51 and the second inductor 52 respectively generate magnetic field lines at

Intervals to mutually interact with the transparent conductors 211 and 212. Accordingly, one of the transparent conductors 211 and 212, which is closest to the signal transmitter 15′, will have the strongest induction to form the detected signal. The control device 23 is thus operable to determine the position of the signal transmitting device 1 relative to the transparent substrate from magnitude of the detected signal.

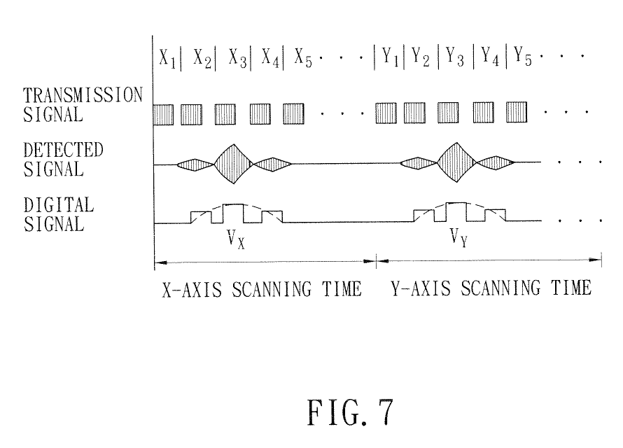

In this embodiment, transmission frequencies associated with the two inductors 51, 52 are different. Further referring to FIG. 7, the signal transmitter 15′ keeps generating transmission signals in the specified frequencies at intervals, and the reference numerals of the transparent conductors 211 and 212 are denoted as X1˜X5 and Y1˜Y5, respectively. When the center 150 of the signal transmitter 15′ approaches the transparent conductors X3 and Y3, magnitudes of the detected signal from X3 and Y3 are larger than those from adjacent transparent conductors X2, X4 and Y2, Y4. After conversion to a digital signal, the peak signal Vₓ and V_{y} could be obtained by comparing magnitudes of adjacent pulses (such as three adjacent pulses forming a set) , which are digitized from the detected signal, to thereby obtain the position of the signal transmitting device 1 relative to the transparent substrate 21 as (X3, Y3). In the implementation, more precise position could be obtained by comparing a larger numbers of adjacent pulses forming a set.

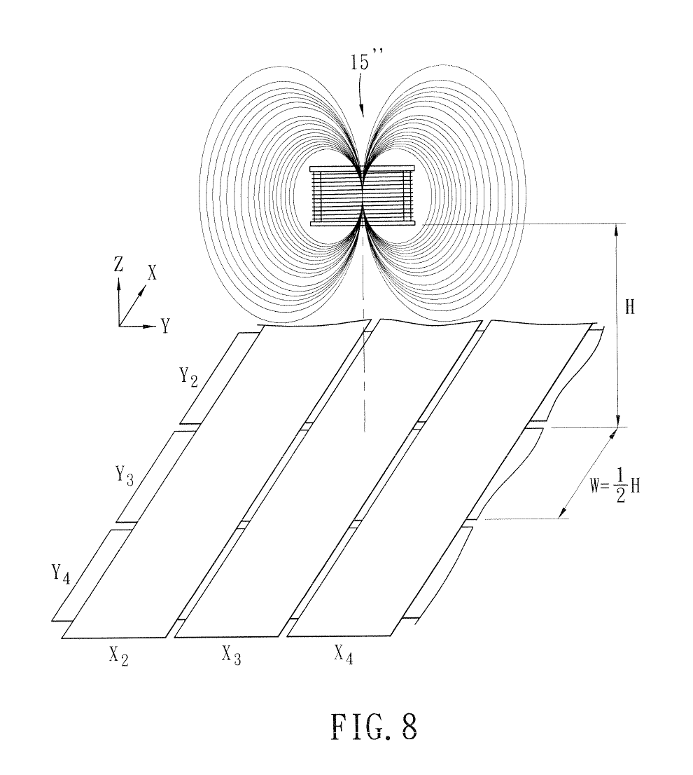

Referring to FIG. 3 and FIG. 8, a second implementation of the signal transmitter 15″ is shown. In this implementation, the pen tip 16 has a. contact end 161 for contacting the transparent substrate 21, and a mounting end 162 opposite to the contact end 161. The signal transmitter 15″ is mounted on the mounting end 162 of the pen tip 16 and forms a predetermined distance H with the contact end 161 of the pen tip 16. The control device 23 determines the position of the signal transmitting device 1 relative to the transparent substrate 21 from valley of the detected signal from at least one of the transparent conductors 211 and 212 sensing the magnetic field from the signal transmitting device 1. In this implementation, the predetermined distance is twice the predetermined width of the transparent conductors 211 and 212 (W₁ equals W₂).

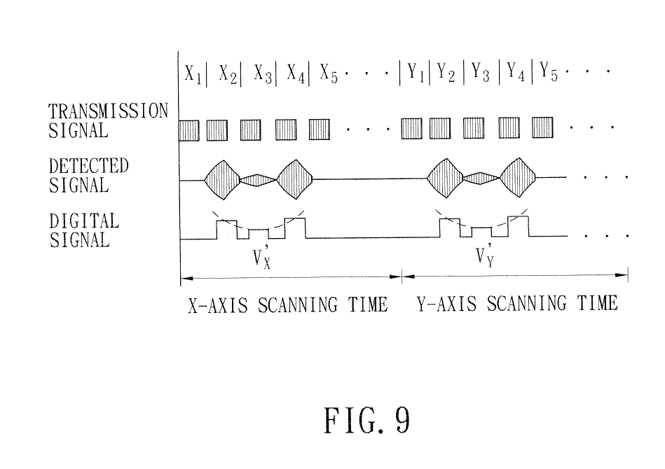

Further referring to FIG. 9, the signal transmitter 15″ keeps generating a transmission signal in the specific frequency at intervals, and the reference numerals of the transparent conductors 211 and 212 are denoted as X1˜X5 and Y1˜Y5, respectively. When the center of the signal transmitter 15″ approaches the transparent conductors X3 and Y3, magnitudes of the detected signal from X3 and Y3 are smaller than those from adjacent transparent conductors X2, X4 and Y2, Y4. After conversion to a digital signal, the valley signal V′ₓ and V′_{y} could be obtained by comparing magnitudes of adjacent pulses, which are digitized from the detected signal, to thereby obtain the position of the signal transmitting device 1 relative to the transparent substrate 21 as (X3, Y3).

To sum up, the electromagnetic inductive input apparatus 100 according to the present invention comprises the signal receiving device 2 having first and second sets of transparent conductors 211 and 212 disposed on the transparent substrate 21. The first set of transparent conductors 211 is in a form of straight non-loop lines spacedly arranged in a first direction, and the second set of transparent conductors 212 is in a form of straight non-loop lines spacedly arranged in a second direction that is transverse to the first direction. The second set of transparent conductors 212 intersects with and is electrically isolated from the first set of transparent conductors 211. Each of the first set of transparent conductors 211 has a predetermined width W₁, and each of the second set of transparent conductors 211 has a predetermined width W₂, so as to impart each of the transparent conductors 211 and 212 with a desired resistance and so as to ensure desired input voltages of the signal receiving device 2 and the signal transmitter 15. Through the design of the signal transmitting device 1, the electromagnetic inductive input apparatus 100 may have wider applications.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electromagnetic inductive input apparatus comprising:
a signal transmitting device including a signal transmitter that has a conductor coil and a ferromagnetic member surrounded by said conductor coil, said signal transmitter being operable to generate a magnetic field; and
a signal receiving device including:
a transparent substrate;
first and second sets of transparent conductors disposed on said transparent substrate, said first set of transparent conductors being in a form of straight non-loop lines spacedly arranged in a first direction, said second set of transparent conductors being in a form of straight non-loop lines spacedly arranged in a second direction that is transverse to the first direction, said second set of transparent conductors intersecting with and being electrically isolated from said first set of transparent conductors, each of said transparent conductors having a predetermined width sufficient to impart each of said transparent conductors with a resistance lower than 1000 ohms; and
a control device electrically coupled to said transparent conductors and operable to detect a detected signal from at least one of said transparent conductors sensing the magnetic field from said signal transmitting device, and to determine a position of said signal transmitting device relative to said transparent substrate from the detected signal.

2. The electromagnetic inductive input apparatus as claimed in claim 1, wherein said ferromagnetic member of said signal transmitter includes at least one pair of orthogonal arm portions, said conductor coil surrounding said arm portions of said ferromagnetic member, said control device determining the position of said signal transmitting device relative to said transparent substrate from peak of the detected signal from said at least one of said transparent conductors sensing the magnetic field from said signal transmitting device.

3. The electromagnetic inductive input apparatus as claimed in claim 1, wherein said signal transmitting device further includes a pen tip having a contact end for contacting said transparent substrate, said signal transmitter being disposed proximate to said pen tip and forming a predetermined distance with said contact end of said pen tip, said control device determining the position of said signal transmitting device relative to said transparent substrate from valley of the detected signal from said at least one of said transparent conductors sensing the magnetic field from said signal transmitting device.

4. The electromagnetic inductive input apparatus as claimed in claim 3, wherein said pen tip further has a mounting end opposite to said contact end, and said signal transmitter is mounted on said mounting end of said pen tip.

5. The electromagnetic inductive input apparatus as claimed in claim 3, wherein said predetermined distance is substantially twice said predetermined width of said transparent conductors.

6. The electromagnetic inductive input apparatus as claimed in claim 1, wherein said control device includes:
a control unit;
a selecting circuit electrically coupled to said control unit and each of said transparent conductors and controlled by said control unit to ground a selected one of said transparent conductors; and
a signal processing circuit electrically coupled to said control unit and each of said transparent conductors, said signal processing circuit detecting and performing filter processing upon the detected signal from the selected one of said transparent conductors;
said control unit determining the position of said signal transmitting device relative to said transparent substrate from the detected signal processed by said signal processing circuit.

7. The electromagnetic inductive input apparatus as claimed in claim 6, wherein said selecting circuit and said signal processing circuit are connected to opposite ends of said transparent conductors, respectively.

8. The electromagnetic inductive input apparatus as claimed in claim 7, wherein said selecting circuit is a demultiplexer circuit.

9. The electromagnetic inductive input apparatus as claimed in claim 6, wherein said selecting circuit is a demultiplexer circuit.

10. The electromagnetic inductive input apparatus as claimed in claim 1, wherein said control device includes:
a control unit;
a selecting circuit electrically coupled to said control unit and each of said transparent conductors and controlled by said control unit to output the detected signal from a selected one of said transparent conductors; and
a signal processing circuit electrically coupled to said control unit andsaidselecting circuit, said signal processing circuit detecting and performing filter processing upon the detected signal from the selected one of said transparent conductors;
said control unit determining the position of said signal transmitting device relative to said transparent substrate from the detected signal processed by said signal processing circuit.

11. The electromagnetic inductive input apparatus as claimed in claim 10, wherein opposite ends of said transparent conductors are connected to ground and said selecting circuit, respectively.

12. The electromagnetic inductive input apparatus as claimed in claim 11, wherein said selecting circuit is a multiplexer circuit.

13. The electromagnetic inductive input apparatus as claimed in claim 10, wherein said selecting circuit is a multiplexer circuit.

14. The electromagnetic inductive input apparatus as claimed in claim 1, wherein the resistance of each of said transparent conductors is about 600 ohms.
